(19) United States
(12) Patent Application Publication
(10) Pub. No.: US 2020/0030981 A1
(43) Pub. Date: Jan. 30, 2020

(54) ROBOT AND ABNORMALITY DETECTION METHOD OF ROBOT

(71) Applicant: Seiko Epson Corporation, Tokyo (JP)

(72) Inventors: Toshiyuki KAMIYA, Fujimi (JP); Hajime KOBAYASHI, Chino (JP)

(21) Appl. No.: 16/524,266

(22) Filed: Jul. 29, 2019

(30) Foreign Application Priority Data
Jul. 30, 2018 (JP) 2018-142030

(51) Int. Cl. B25J 9/16; B25J 13/08; B25J 19/06

(52) U.S. Cl. CPC B25J 9/1674; B25J 19/06; B25J 13/085; B25J 9/1694

(57) ABSTRACT

A robot includes a robot arm, a first member and a second member placed between a base of the robot arm and an installation part, a first force sensor and a second force sensor placed in contact with both the first member and the second member on a plane in a normal direction along a direction in which the base and the installation part are arranged, an on-virtual line component calculation part that obtains a first translational force component on a virtual line from output of the first force sensor and obtains a second translational force component on the virtual line from output of the second force sensor, and a determination part that outputs a signal when determining that the first force sensor or the second force sensor is abnormal based on a difference between the first translational force component and the second translational force component.

The present application is based on, and claims priority from, JP Application Serial Number 2018-142030, filed Jul. 30, 2018, the disclosure of which is hereby incorporated by reference herein in its entirety.

### BACKGROUND

### 1. Technical Field

The present disclosure relates to a robot and an abnormality detection method of the robot.

### 2. Related Art

A robot system disclosed in JP-A-2012-218094 includes a robot, a first sensor and a second sensor that respectively output a predetermined first detection value and second detection value based on a force acting on the robot, and a control unit that determines that an abnormality occurs in the robot when a difference between the first detection value and the second detection value exceeds a threshold value. Further, JP-A-2012-218094 discloses that the first sensor and the second sensor are placed to overlap between e.g. a base platform and a proximal end arm.

In the robot system disclosed in JP-A-2012-218094, the first sensor and the second sensor are placed to overlap, and thereby, rigidity of a sensor part is lower.

Accordingly, there is a problem that positioning accuracy of the robot is lower.

### SUMMARY

A robot according to an application example of the present disclosure includes a robot arm, a first member and a second member placed between a base of the robot arm and an installation part, a first force sensor and a second force sensor placed in contact with both the first member and the second member on a plane in a normal direction along a direction in which the base and the installation part are arranged, an on-virtual line component calculation part that obtains a translational force component on a virtual line from output of the first force sensor as a first translational force component and obtains a translational force component on the virtual line from output of the second force sensor as a second translational force component, and a determination part that outputs a signal when determining that the first force sensor or the second force sensor is abnormal based on a difference between the first translational force component and the second translational force component.

### BRIEF DESCRIPTION OF THE DRAWINGS

FIG. 1 is a perspective view showing a robot according to a first embodiment of the present disclosure.

FIG. 2 is a block diagram of the robot shown in FIG. 1.

FIG. 3 is a partially enlarged exploded perspective view of a force detection unit shown in FIG. 1.

FIG. 4 shows the force detection unit shown in FIG. 3 as seen from vertically above.

FIG. 5 is a side view of the force detection unit shown in FIG. 4.

FIG. 6 is a flowchart for explanation of an abnormality detection method of the robot shown in FIGS. 1 and 2.

FIG. 7 shows a resultant force coordinate system in addition to the force detection unit shown in FIG. 4.

FIG. 8 is an exploded perspective view showing a force detection unit contained in a robot according to a second embodiment of the present disclosure.

FIG. 9 shows the force detection unit shown in FIG. 8 as seen from vertically above.

FIG. 10 shows a modified example of the force detection unit shown in FIG. 9.

### DESCRIPTION OF EXEMPLARY EMBODIMENTS

As below, preferred embodiments of a robot and an abnormality detection method of the robot according to the present disclosure will be explained in detail according to the accompanying drawings.

### First Embodiment

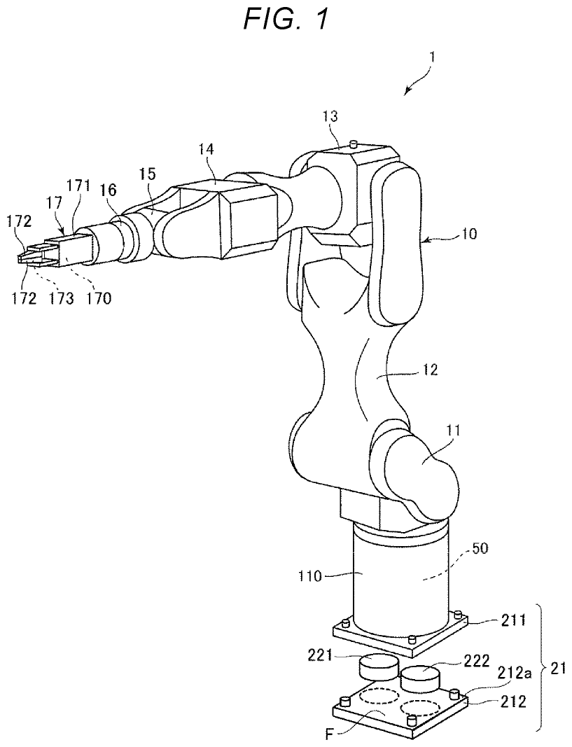

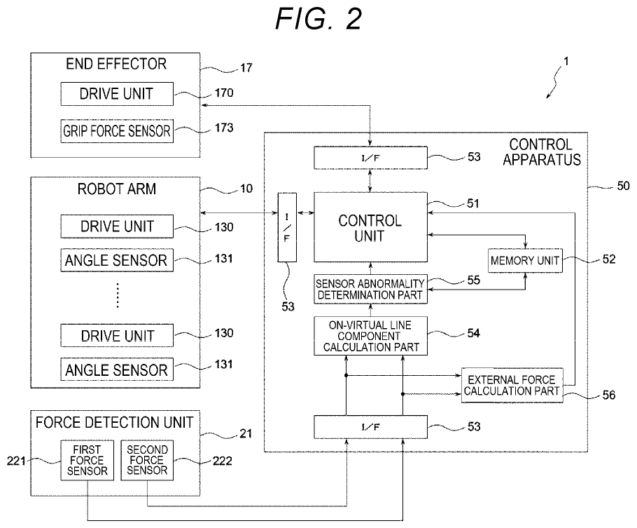

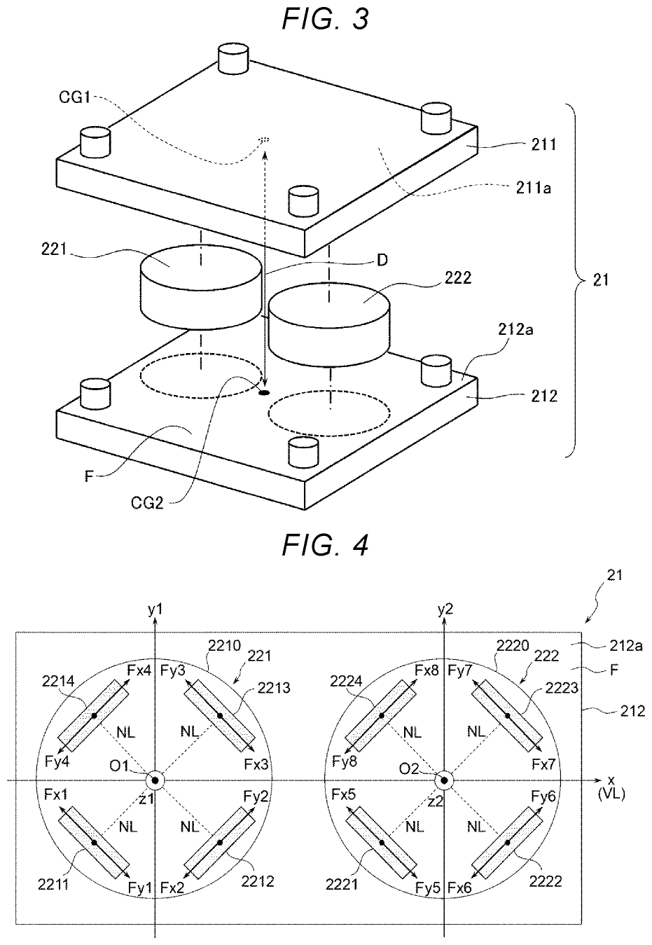

FIG. 1 is the perspective view showing a robot according to the first embodiment of the present disclosure with a force detection unit exploded. FIG. 2 is the block diagram of the robot shown in FIG. 1. Note that, hereinafter, a base 110 side of a robot arm 10 is referred to as “proximal end side” and the opposite side, i.e., an end effector 17 side of the robot arm 10 is referred to as “distal end side”. Further, the upside in FIGS. 1 and 3 is referred to as “upper” and the downside is referred to as “lower”.

A robot 1 shown in FIG. 1 is a system that performs work of feeding, removing, carrying, assembly, etc. of objects e.g. precision apparatuses and components forming the precision apparatuses using the robot arm 10 with the end effector 17 attached thereto. The robot 1 includes the robot arm 10 having a plurality of arms 11 to 16, the end effector 17 attached to the distal end side of the robot arm 10, and a control apparatus 50 that controls operation thereof. As below, first, an outline of the robot 1 will be explained.

The robot 1 is a so-called six-axis vertical articulated robot. As shown in FIG. 1, the robot 1 includes the base 110, and the robot arm 10 pivotably coupled to the base 110.

The base 110 is fixed to an installation part e.g. a floor, wall, ceiling, movable platform, or the like via a force detection unit 21. The force detection unit 21 will be described later. Note that, in the following description, the case where the base 110 is fixed to a floor surface is explained as an example. The robot arm 10 has the arm 11 (first arm) pivotably coupled to the base 110, the arm 12 (second arm) pivotably coupled to the arm 11, the arm 13 (third arm) pivotably coupled to the arm 12, the arm 14 (fourth arm) pivotably coupled to the arm 13, the arm 15 (fifth arm) pivotably coupled to the arm 14, and the arm 16 (sixth arm) pivotably coupled to the arm 15. Note that parts that flex or pivot two members coupled to each other of the base 110 and the arms 11 to 16 form “joint parts”.

Further, as shown in FIG. 2, the robot 1 has a drive unit 130 that drives the respective joint parts of the robot arm 10 and an angle sensor 131 that detects e.g. rotation angles as drive states of the respective joint parts of the robot arm 10. The drive unit 130 includes e.g. a motor and a reducer. The angle sensor 130 includes e.g. a magnetic or optical rotary encoder.

The end effector 17 is attached to a distal end surface of the arm 16 of the robot 1. Note that another force sensor than the force sensor to be described later may be placed between the arm 16 and the end effector 17.

The end effector 17 is a gripping hand that grips an object. As shown in FIG. 1, the end effector 17 has a main body 171, a drive part 170 placed in the main body 171, a pair of gripping parts 172 that open and close by drive power from the drive part 170, and a grip force sensor 173 provided in the gripping part 172.

Here, the drive part 170 includes e.g. a motor and a transmission mechanism such as gears that transmit the drive power from the motor to the pair of gripping parts 172. Further, the pair of gripping parts 172 open and close by drive power from the drive part 170. Thereby, the pair of gripping parts 172 may grip and hold an object therebetween and release the object held between the pair of gripping parts 172. The grip force sensor 173 is e.g. a resistive or capacitive pressure sensor, and is placed in the gripping part 172 or between the gripping part 172 and the drive part 170 and detects a force applied between the pair of gripping parts 172. Note that the end effector 17 is not limited to the above described gripping hand, but may be e.g. an end effector that holds an object by suction. In this specification, “hold” has a concept including both suction and grip. Further, “suction” has a concept including suction by a magnetic force, suction by negative pressure, etc. “Force” has a concept including both a translational force and moment unless otherwise noted. Furthermore, the number of fingers of the gripping hand used for the end effector 17 is not limited to two, but may be three or more.

The control apparatus 50 shown in FIGS. 1 and 2 has a function of controlling driving of the robot arm 10 based on a detection result of the angle sensor 131. Further, the control apparatus 50 has a function of determining a grip force of the end effector 17 and an operation condition of the robot 1 based on a detection result of the gripping force sensor 173 and the operation condition of the robot 1.

The control apparatus 50 has a control unit 51 including a CPU (Central Processing Unit), a memory unit 52 including a ROM (Read Only Memory) and a RAM (Random Access Memory), and an I/F (interface circuit) 53. In the control apparatus 50, the control unit 51 reads and executes programs stored in the memory unit 52 as appropriate, and thereby, processing of controlling motion of the robot arm 10 and the end effector 17, abnormality alarming, etc. is realized. Further, the I/F 53 is communicably configured with the robot arm 10 and the end effector 17.

Note that, in the drawing, the control apparatus 50 is placed within the base 110 of the robot 1, however, may be placed outside of the base 110 or within the robot arm 10. Further, a display device including a monitor such as a display, an input device including e.g. a mouse, keyboard, etc. may be connected to the control apparatus 50.

The robot 1 shown in FIGS. 1 and 2 includes the force detection unit 21 provided closer to the proximal end side than the robot arm 10 between the base 110 and the floor surface.

The force detection unit 21 includes a first member 211 and a second member 212. The first member 211 and the second member 212 according to the embodiment are arranged along a direction in which the base 110 and the floor surface (installation part) are arranged. That is, the first member 211 and the second member 212 are arranged one above the other along the vertical direction. Further, the first member 211 is provided in contact with the lower surface of the base 110. On the other hand, the second member 212 is provided in contact with the floor surface. Those first member 211 and second member 212 are plate-like members respectively having rectangular principal surfaces as seen from the vertical direction.

Further, the force detection unit 21 includes a first force sensor 221 and a second force sensor 222 provided between the first member 211 and the second member 212. The first force sensor 221 and the second force sensor 222 are placed in parallel on a plane F with a normal line along a direction in which the base 110 and the installation part are arranged, i.e., the vertical direction. In the embodiment, an upper surface 212a of the second member 212 corresponds to the plane F.

The first force sensor 221 is placed in contact with both a lower surface 211a of the first member 211 and the upper surface 212a of the second member 212. Similarly, the second force sensor 222 is also placed in contact with both the lower surface 211a of the first member 211 and the upper surface 212a of the second member 212.

Note that, in the embodiment, the direction in which the base 110 and the installation part are arranged is equal to a direction in which the first member 211 and the second member 212 are arranged. The direction in which the first member 211 and the second member 212 are arranged refers to a direction connecting centers of gravity of areas overlapping with each other (hereinafter, referred to as “overlapping areas”) of the lower surface 211a of the first member 211 and the upper surface 212a of the second member 212 in a plan view of the plane F. Specifically, it is only necessary that a direction D in FIG. 3 in which a center of gravity CG1 of the overlapping area at the lower surface 211a side and a center of gravity CG2 of the overlapping area at the upper surface 212a side are connected is parallel to the normal line of the plane F between the lower surface 211a and the upper surface 212a, though the shapes, sizes, etc. may be different from each other. Further, in the embodiment, particularly, the normal line of the plane F is parallel to the vertical direction. That is, the direction in which the first member 211 and the second member 212 are connected according to the embodiment is the vertical direction.

The above described force detection unit 21 is a sensor that senses a force applied to the robot arm 10. When a force is applied to the robot arm 10 or the end effector 17, the force is transmitted through the robot arm 10 to the force detection unit 21, and a size and a direction of the force may be sensed in the force detection unit 21. Thereby, collision sensing can be performed in the robot 1.

Further, the force detection unit 21 is communicably connected to an on-virtual line component calculation part 54 and an external force calculation part 56 via the I/F 53 (interface).

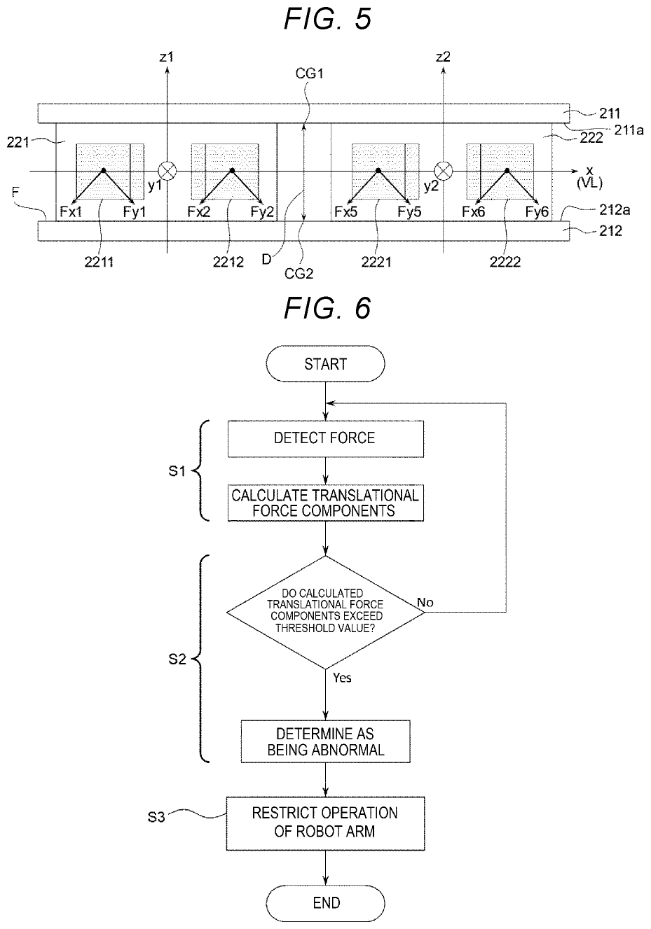

FIG. 3 is the partially enlarged exploded perspective view of the force detection unit 21 shown in FIG. 1. FIG. 4 shows the force detection unit 21 shown in FIG. 3 as seen from vertically above. FIG. 5 is the side view of the force detection unit 21 shown in FIG. 4.

In the force detection unit 21 shown in FIG. 4, the first force sensor 221 and the second force sensor 222 are shown to be seen through.

The first force sensor 221 shown in FIG. 4 is a six-axis force sensor including a casing 2210 and four sensor units 2211 to 2214 provided within the casing 2210. Predetermined calculation processing is performed on outputs from these sensor units 2211 to 2214, and thereby, translational forces with respect to an x-axis, a y1-axis, and a z1-axis of a first sensor coordinate system shown in FIG. 4 and moment about the x-axis, the y1-axis, and the z1-axis may be obtained.

Each of the sensor units 2211 to 2214 is an element including a plurality of flat quartz crystal plates (not shown) and converting an applied force into electric charge using the piezoelectric effect of the quartz crystal plates. The respective quartz crystal plates are stacked so that crystal orientations may be different from one another. Thereby, from each quartz crystal plate, an output Fz based on a force in a direction orthogonal to the principal surface thereof and outputs Fx, Fy based on forces in two directions orthogonal to each other in the principal surface are obtained. Note that, in the following description, the principal surfaces of the respective quartz crystal plates of the sensor units 2211 to 2214 may be also referred to as principal surfaces of the sensor units 2211 to 2214.

Further, as shown in FIG. 4, the sensor units 2211 to 2214 are placed so that perpendicular lines NL of the principal surfaces may respectively pass a center O1 of the casing 2210, in other words, the principal surfaces may face the center O1. The four sensor units 2211 to 2214 are placed at equal angular intervals around the center O1. The positions of the four sensor units 2211 to 2214 along the z1-axis are the same with one another.

Note that, in FIG. 4, the x-axis of the first sensor coordinate system passes between the sensor unit 2211 and the sensor unit 2214 and between the sensor unit 2212 and the sensor unit 2213. Further, in FIG. 4, the y1-axis of the first sensor coordinate system passes between the sensor unit 2211 and the sensor unit 2212 and between the sensor unit 2213 and the sensor unit 2214.

The output Fx obtained from the sensor unit 2211 is referred to as “Fx1” and the output Fy is referred to as “Fy1”. The output Fx obtained from the sensor unit 2212 is referred to as “Fx2” and the output Fy is referred to as “Fy2”. The output Fx obtained from the sensor unit 2213 is referred to as “Fx3” and the output Fy is referred to as “Fy3”. The output Fx obtained from the sensor unit 2214 is referred to as “Fx4” and the output Fy is referred to as “Fy4”.

As shown in FIG. 4, the direction of the output Fx1 and the direction of the output Fx3 respectively projected on the plane F are opposite to each other. Similarly, the direction of the output Fx2 and the direction of the output Fx4 respectively projected on the plane F are opposite to each other. Similarly, the direction of the output Fy1 and the direction of the output Fy3 respectively projected on the plane F are opposite to each other. Similarly, the direction of the output Fy2 and the direction of the output Fy4 respectively projected on the plane F are opposite to each other.

Further, as shown in FIG. 5, the direction of the output Fx1, the direction of the output Fx2, the direction of the output Fy1, and the direction of the output Fy2 are respectively nonparallel to both the x-axis and the y1-axis. Further, also, the direction of the output Fx3, the direction of the output Fx4, the direction of the output Fy3, and the direction of the output Fy4 are respectively nonparallel to both the x-axis and the y1-axis (not shown in FIG. 5).

Note that the directions are not limited to those, but may be parallel.

The second force sensor 222 shown in FIG. 4 is a six-axis force sensor including a casing 2220 and four sensor units 2221 to 2224 provided within the casing 2220. Predetermined calculation processing is performed on outputs from these sensor units 2221 to 2224, and thereby, translational forces with respect to an x-axis, a y2-axis, and a z2-axis of a second sensor coordinate system shown in FIG. 4 and moment about the x-axis, the y2-axis, and the z2-axis may be obtained.

Note that the x-axis in the first sensor coordinate system and the x-axis in the second sensor coordinate system are common.

Each of the sensor units 2221 to 2224 is an element including a plurality of flat quartz crystal plates (not shown) and converting an applied force into electric charge using the piezoelectric effect of the quartz crystal plates. The respective quartz crystal plates are stacked so that crystal orientations may be different from one another. Thereby, from the respective quartz crystal plates, an output Fz based on a force in a direction orthogonal to the principal surface thereof and outputs Fx, Fy based on forces in two directions orthogonal to each other in the principal surface are obtained. Note that, in the following description, the principal surfaces of the respective quartz crystal plates of the sensor units 2221 to 2224 may be also referred to as principal surfaces of the sensor units 2221 to 2224.

Further, as shown in FIG. 4, the sensor units 2221 to 2224 are placed so that perpendicular lines NL of the principal surfaces may respectively pass a center O2 of the casing 2220, in other words, the principal surfaces may face the center O2. The four sensor units 2221 to 2224 are placed at equal angular intervals around the center O2. The positions of the four sensor units 2221 to 2224 along the z2-axis are the same with one another.

Note that, in FIG. 4, the x-axis of the second sensor coordinate system passes between the sensor unit 2221 and the sensor unit 2224 and between the sensor unit 2222 and the sensor unit 2223. Further, in FIG. 4, the y2-axis of the second sensor coordinate system passes between the sensor unit 2221 and the sensor unit 2222 and between the sensor unit 2223 and the sensor unit 2224.

The output Fx obtained from the sensor unit 2221 is referred to as “Fx5” and the output Fy is referred to as “Fy5”. The output Fx obtained from the sensor unit 2222 is referred to as “Fx6” and the output Fy is referred to as “Fy6”. The output Fx obtained from the sensor unit 2223 is referred to as “Fx7” and the output Fy is referred to as “Fy7”. The output Fx obtained from the sensor unit 2224 is referred to as “Fx8” and the output Fy is referred to as “Fy8”.

As shown in FIG. 4, the direction of the output Fx5 and the direction of the output Fx7 respectively projected on the plane F are opposite to each other. Similarly, the direction of the output Fx6 and the direction of the output Fx8 respectively projected on the plane F are opposite to each other. Similarly, the direction of the output Fy5 and the direction of the output Fy7 respectively projected on the plane F are opposite to each other. Similarly, the direction of the output Fy6 and the direction of the output Fy8 respectively projected on the plane F are opposite to each other.

Further, the direction of the output Fx5, the direction of the output Fx6, the direction of the output Fy5, and the direction of the output Fy6 are respectively nonparallel to both the x-axis and the y2-axis (not shown). Further, also, the direction of the output Fx7, the direction of the output Fx8, the direction of the output Fy7, and the direction of the output Fy8 are respectively nonparallel to both the x-axis and the y2-axis.

Note that the directions are not limited to those, but may be parallel.

As described above, the first force sensor 221 detects a force based on the outputs from the plurality of sensor units 2211 to 2214. Similarly, the second force sensor 222 detects a force based on the outputs from the plurality of sensor units 2221 to 2224. In the case where both the first force sensor 221 and the second force sensor 222 are normal, when the same force is applied, the sensors are set to output the same value. For example, the sensors are set so that the output Fx1 and output Fx5 and the output Fy1 and output Fy5 may be the same. The sensors are set so that the other output Fx, output Fy, and output Fz may satisfy the same relationship.

Note that the number of sensor units in the each force sensor is not particularly limited, but may be two, three, five or more.

Further, as shown in the embodiment, each force sensor is not limited to a configuration as a module formed by combination of a plurality of sensor units in advance, however, e.g. a configuration in which eight sensor units are directly assembled in the respective first member and second member and a resultant force is output using a combination of an arbitrary number (e.g. four) of the sensor units as the first force sensor and a combination of the rest (e.g. four) of the sensor units as the second force sensor. In the case of the configuration, even when one sensor unit fails and the force detection unit 21 becomes abnormal, only the single sensor unit may be replaced and low-cost repairs without waste can be made.

On the other hand, with a configuration in which the first force sensor 221 and the second force sensor 222 are assembled as modules as shown in the embodiment, the assembly manufacture, sensitivity calibration, etc. of the force detection unit 21 can be performed more easily.

The control apparatus 50 includes the on-virtual line component calculation part 54, a sensor abnormality determination part 55, and the external force calculation part 56.

Of the parts, the on-virtual line component calculation part 54 obtains a translational force component on a virtual line from the output of the first force sensor 221 and a translational force component on the virtual line from the output of the second force sensor 222. Here, the virtual line refers to an arbitrary line virtualized by the on-virtual line component calculation part 54. Note that the virtual line will be described in detail later.

The sensor abnormality determination part 55 determines whether or not the first force sensor 221 or the second force sensor 222 is abnormal based on a calculation result of the on-virtual line component calculation part 54.

The external force calculation part 56 calculates a resultant force based on the output of the first force sensor 221 and the output of the second force sensor 222.

As above, the outline of the robot 1 is explained. In the force detection unit 21 of the robot 1, as described above, both the first force sensor 221 and the second force sensor 222 are mounted in parallel on the plane F. Accordingly, the thickness of the force detection unit 21 may be suppressed and rigidity of the force detection unit is harder to be lower, and thereby, lowering of the positioning accuracy of the robot 1 may be prevented.

Further, it is necessary for the robot 1 to secure the health of the force detection unit 21, when a force is applied to the robot arm 10, the end effector 17, or the like, in order to accurately sense the force in the force detection unit 21 and operate according to the force. In the robot 1 according to the embodiment, the detection value of the applied force is output, whether or not there is an abnormality in the force detection unit 21 is determined, and, when there is an abnormality, a signal is output. Thereby, an abnormality may be detected earlier and control to restrict the driving of the robot arm 10 may be performed.

As below, the operation of the robot 1 will be explained.

FIG. 6 is the flowchart for explanation of the abnormality detection method of the robot 1 shown in FIGS. 1 and 2.

First, the robot 1 starts a normal operation. The normal operation includes e.g. work of feeding, removing, carrying, assembly, etc. of objects e.g. precision apparatuses and components forming the precision apparatuses.

After the normal operation is started, as step S1, a force is detected by the force detection unit 21. When a force is applied to the force detection unit 21, the force is transmitted to the first force sensor 221 and the second force sensor 222. Then, a translational force component on the virtual line VL shown in FIG. 4 is obtained as “first translational force component fx1” from the output of the first force sensor 221. Further, a translational force component on the virtual line VL is obtained as “second translational force component fx2” from the output of the second force sensor 222. In the embodiment, for convenience of explanation, as shown in FIG. 4, the x-axis common between the first sensor coordinate system and the second sensor coordinate system is set as the virtual line VL.

Specifically, when a force is applied to the first force sensor 221, as described above, the output Fx1, the output Fy1, the output Fx2, the output Fy2, the output Fx3, the output Fy3, the output Fx4, and the output Fy4 are obtained as the outputs from the four sensor units 2211 to 2214 from the first force sensor 221. Further, when a force is applied to the second force sensor 222, as described above, the output Fx5, the output Fy5, the output Fx6, the output Fy6, the output Fx7, the output Fy7, the output Fx8, and the output Fy8 are obtained as the outputs from the four sensor units 2221 to 2224 from the second force sensor 222. These outputs are input to the external force calculation part 56 of the control apparatus 50 and input to the on-virtual line component calculation part 54. As below, the calculation in the on-virtual line component calculation part 54 and the calculation in the external force calculation part 56 will be sequentially explained.

Of the calculations, in the on-virtual line component calculation part 54, first, the first translational force component fx1 is calculated based on the following expression (1) from the output of the first force sensor 221.

fx1=−Fx1+Fy1 −Fx2+Fy2+Fx3−Fy3+Fx4−Fy4 (1)

Then, the second translational force component fx2 is calculated based on the following expression (2) from the output of the second force sensor 222.

fx2=−Fx5+Fy5−Fx6+Fy6+Fx7−Fy7+Fx8−Fy8 (2)

Then, as step S2, whether or not the first force sensor 221 or the second force sensor 222 is abnormal is determined based on the calculated first translational force component fx1 and second translational force component fx2. Specifically, the first translational force component fx1 and the second translational force component fx2 calculated in the on-virtual line component calculation part 54 are input to the sensor abnormality determination part 55. In the sensor abnormality determination part 55, a difference |fx1−fx2| between the first translational force component fx1 and the second translational force component fx2 is calculated and a threshold value stored in the memory unit 52 is read out. For the threshold value, as an example, a value based on an actual value like the minimum value of differences produced when abnormalities actually occurred based on data acquired in the past may be employed. Further, the difference is obtained as an absolute value. Then, whether or not the calculated difference exceeds the threshold value is determined.

When the calculated difference |fx1−fx2| is equal to or smaller than the threshold value, both the first force sensor 221 and the second force sensor 222 are determined as being normal. Specifically, both the first force sensor 221 and the second force sensor 222 are sandwiched by the above described first member 211 and second member 212, and thus, when a force is applied to the force detection unit 21, if both the first force sensor 221 and the second force sensor 222 are normal, the first translational force component fx1 and the second translational force component fx2 are substantially equal to each other. Accordingly, when the difference |fx1−fx2| is equal to or smaller than the threshold value, both the first force sensor 221 and the second force sensor 222 may be determined as being normal. In this case, the processing returns to step S1.

On the other hand, when the calculated difference |fx1−fx2| exceeds the threshold value, either the first force sensor 221 or the second force sensor 222 is determined as being abnormal. For example, when the first force sensor 221 is normal and the second force sensor 222 is abnormal, the first translational force component fx1 shows a proper value, but the second translational force component fx2 deviates from a proper value. Accordingly, the difference |fx1−fx2| increases and exceeds the threshold value. In the sensor abnormality determination part 55, either the first force sensor 221 or the second force sensor 222 is determined as being abnormal thereby. When making the determination, the sensor abnormality determination part 55 outputs a signal based thereon to the control unit 51.

Note that, in the calculation in the sensor abnormality determination part 55, in place of the difference between the first translational force component fx1 and the second translational force component fx2, e.g. a ratio of the first translational force component fx1 to the second translational force component fx2 may be calculated and whether or not the ratio exceeds a threshold value may be determined.

The control unit 51 receiving the signal restricts the operation of the robot arm 10 or the end effector 17 as step S3. Thereby, the operation of the robot arm 10 etc. when the force detection unit 21 is not normal may be prevented. As a result, damage on an object by an unintended operation and other failures may be prevented.

Note that the control after step S2 is not limited to the above described step S3. For example, after step S2, a warning indicating that either the first force sensor 221 or the second force sensor 222 is abnormal may be issued.

On the other hand, in the external force calculation part 56, a resultant force is calculated based on the output of the first force sensor 221 and the output of the second force sensor 222. The force is calculated from not only the output of the first force sensor 221 or only the output of the second force sensor 222, but the resultant force is calculated using both, and thereby, the force may be calculated with higher accuracy. As a result, stability of the operation and the positioning accuracy of the robot 1 may be improved.

Here, a calculation example of the resultant force is explained.

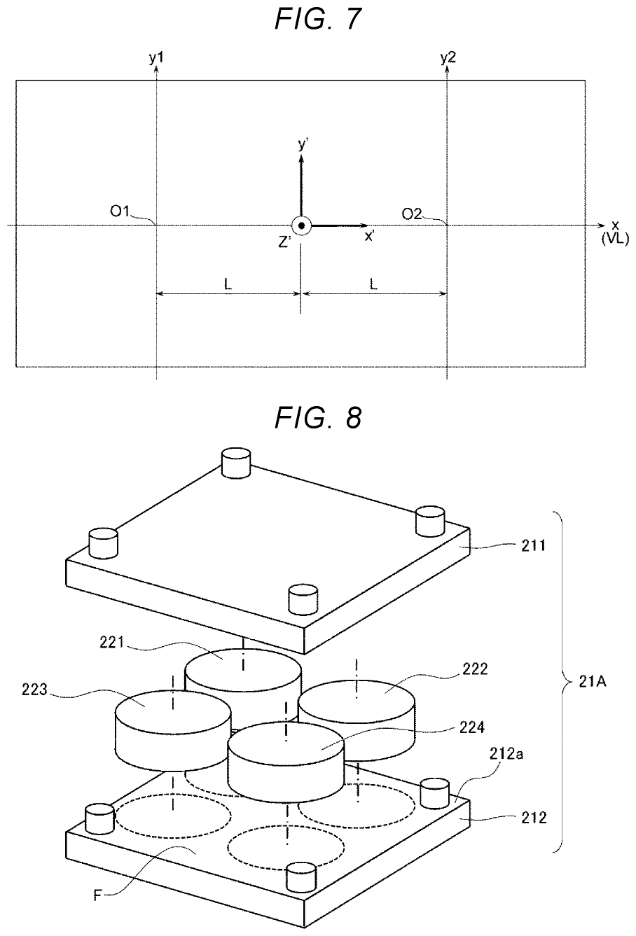

FIG. 7 shows the resultant force coordinate system in addition to the force detection unit shown in FIG. 4. The resultant force to be calculated is obtained as a force in a resultant force coordinate system defined by an x′-axis, a y′-axis, and a z′-axis set between the first force sensor 221 and the second force sensor 222.

The resultant force coordinate system shown in FIG. 7 is a three-axis orthogonal coordinate system formed by the z′-axis parallel to the above described z1-axis and z2-axis, the x′-axis equal to the above described x-axis, and the y′-axis parallel to the above described y1-axis and y2-axis with an origin at a midpoint of the center O1 as the origin of the first sensor coordinate system and the center O2 as the origin of the second sensor coordinate system. In this regard, a distance L between the center O1 and the midpoint and a distance L between the center O2 and the midpoint are equal to each other.

Further, from the first force sensor 221 as the six-axis force sensor, as described above, the translational forces (fx1, fy1, fz1) with respect to the x-axis, the y1-axis, and the z1-axis of the first sensor coordinate system and the moment (mx1, my1, mz1) about the x-axis, the y1-axis, and the z1-axis are output as force sense values. Note that the force sense values are calculated using a known method based on the outputs from the above described four sensor units 2211 to 2214.

Similarly, from the second force sensor 222 as the six-axis force sensor, as described above, the translational forces (fx2, fy2, fz2) with respect to the x-axis, the y2-axis, and the z2-axis of the second sensor coordinate system and the moment (mx2, my2, mz2) about the x-axis, the y2-axis, and the z2-axis are output as force sense values. Note that the force sense values are calculated using a known method based on the outputs from the above described four sensor units 2221 to 2224.

Then, in the external force calculation part 56, a resultant force in the resultant force coordinate system is calculated from the above described force sense values based on the following expressions (3) to (8). The resultant force is calculated as a translational force fx′ with respect to the x′-axis, a translational force fy′ with respect to the y′-axis, a translational force fz′ with respect to the z′-axis, moment mx′ about the x′-axis, moment my′ about the y′-axis, and moment mz′ about the z′-axis.

fx′=fx1+fx2 (3)

fy′=fy1+fy2+mz1/L−mz2/L (4)

fz′=fz1+fz2−my1/L+my2/L (5)

mx′=mx1+mx2 (6)

my′=fz1·L−fz2·L (7)

mz′=−fy1·L+fy2·L (8)

In the above described manner, the resultant force may be calculated.

Note that the calculation of the resultant force is not essential, and the force sense values from the first force sensor 221 or the force sense values from the second force sensor 222 as they are without composition may be output from the external force calculation part 56. Further, the calculation method of the resultant force is not limited to the above described method, but may be any method. When the first force sensor 221 or the second force sensor 222 is determined as being abnormal in the sensor abnormality determination part 55, the resultant force calculated in the external force calculation part 56 may be processed as an abnormal value.

The above described first force sensor 221 and second force sensor 222 are placed between the first member 211 and the second member 212, and it is preferable that the first member 211 and the second member 212 are respectively substantially rigid bodies. Thereby, when a force is applied to the force detection unit 21, an equal force is transmitted to the first force sensor 221 and the second force sensor 222. Accordingly, in the above described manner, abnormality determination of the first force sensor 221 or the second force sensor 222 based on the difference |fx1−fx2| between the first translational force component fx1 and the second translational force component fx2 can be performed and the calculation of the resultant force can be performed.

Note that constituent materials of the first member 211 and the second member 212 include e.g. iron alloys such as stainless steel, aluminum alloys, and copper alloys.

The lengths of the first member 211 and the second member 212 in the vertical direction, i.e., the thicknesses of the first member 211 and the second member 212 are slightly different according to the constituent materials, sizes, or the like, and preferably equal to or larger than 3 mm and more preferably from 5 mm to 50 mm as examples. Though that depends on the constituent materials, for example, in the cases of the above described constituent materials, when the thicknesses of the first member 211 and the second member 212 are within the range, the first member 211 and the second member 212 may be regarded as rigid bodies.

As described above, the abnormality detection method of the robot 1 is the method of detecting an abnormality of the robot 1 having the robot arm 10, the first member 211 and the second member 212 placed between the base 110 and the floor surface as the installation part, and the first force sensor 221 and the second force sensor 222 placed in contact with both the first member 211 and the second member 212 on the plane F with the normal line along the direction in which the base 110 and the installation part are arranged. Further, the abnormality detection method includes step S1 of obtaining the translational force component on the virtual line VL from the output of the first force sensor 221 as the first translational force component fx1 and the translational force component on the virtual line VL from the output of the second force sensor 222 as the second translational force component fx2 and step S2 of determining whether or not the difference between the first translational force component fx1 and the second translational force component fx2 exceeds the threshold value and, when the difference exceeds the threshold value, determining that the first force sensor 221 or the second force sensor 222 is abnormal.

According to the abnormality detection method, whether or not there is an abnormality in the force detection unit 21 is determined and, when there is an abnormality, a signal is output. Thereby, an abnormality may be detected earlier and control to restrict the driving of the robot arm 10 may be performed. Further, in the force detection unit 21, both the first force sensor 221 and the second force sensor 222 are mounted on the plane F as described above. Accordingly, the rigidity of the force detection unit 21 is harder to be lower, and lowering of the positioning accuracy of the robot 1 may be prevented.

Further, the robot 1 has the robot arm 10, the first member 211 and the second member 212 placed between the base 110 and the floor surface as the installation part, the first force sensor 221 and the second force sensor 222 placed in contact with both the first member 211 and the second member 212 on the plane F with the normal line along the direction in which the base 110 and the installation part are arranged, the on-virtual line component calculation part 54 that obtains the translational force component on the virtual line VL from the output of the first force sensor 221 as the first translational force component fx1 and the translational force component on the virtual line VL from the output of the second force sensor 222 as the second translational force component fx2, and the sensor abnormality determination part 55 that outputs a signal when determining that the first force sensor 221 or the second force sensor 222 is abnormal based on the difference between the first translational force component fx1 and the second translational force component fx2.

According to the robot 1, the first force sensor 221 and the second force sensor 222 are not placed to overlap as those in related art, but the first force sensor 221 and the second force sensor 222 are provided in parallel on the upper surface 212a of the second member 212, i.e. the plane F. Accordingly, the rigidity of the force detection unit 21 may be made higher compared to the case in related art. As a result, deformation of the force detection unit 21 with the operation of the robot 1 may be suppressed and the positioning accuracy of the robot 1 may be improved.

In combination with the effect, the abnormality determination of the first force sensor 221 or the second force sensor 222 can be performed with the force detection by the force detection unit 21.

Therefore, the control unit 51 of the control apparatus 50 receives the signal from the sensor abnormality determination part 55 and restricts driving of the robot arm 10. Thereby, the operation of the robot 1 can be restricted so that the robot 1 may not operate when an abnormality occurs in the force detection unit 21. As a result, damage on an object by an unintended operation and other failures e.g. lowering of the positioning accuracy may be prevented.

The external force calculation part 56 of the control apparatus 50 calculates the resultant force based on the output of the first force sensor 221 and the output of the second force sensor 222. Thereby, the force applied to the first force sensor 221 and the second force sensor 222 may be obtained with higher accuracy. As a result, stability of the operation and the positioning accuracy of the robot 1 may be improved.

The measurement principle of the first force sensor 221 and the second force sensor 222 includes e.g. the piezoelectric system, strain gauge system, and electrostatic system. Of the systems, the piezoelectric system is preferably used and, particularly, the piezoelectric system using quartz crystal as in the embodiment is more preferably used. That is, it is preferable that the first force sensor 221 and the second force sensor 222 respectively are the sensors having quartz crystal. The sensors using quartz crystal generate particularly accurate amounts of electric charge for forces having a wide variety of magnitude, and thereby, a balance between high sensitivity and wide range may be easily achieved. Accordingly, the sensors using quartz crystal are useful as the first force sensor 221 and the second force sensor 222 used for the robot 1.

The first force sensor 221 and the second force sensor 222 may be respectively three-axis force sensors, however, preferably the six-axis force sensors. Thereby, the translational forces along the three axes and the moment about the three axes may be obtained. Accordingly, the force applied to the force detection unit 21 may be obtained with higher accuracy.

In the embodiment, the x-axis is set as the virtual line VL as described above, however, the virtual line VL is a straight line arbitrary drawn, not limited to the setting. Note that the virtual line VL is preferably set to a straight line passing through the first force sensor 221 or the second force sensor 222 and more preferably set to a straight line parallel to none of the direction of the output Fx, the direction of the output Fy, and the direction of the output Fz in the quartz crystal plates contained in the sensor units 2211 to 2214 and the sensor units 2221 to 2224. That is, it is preferable that the output axis of the first force sensor 221 and the output axis of the second force sensor 222 are respectively nonparallel to the virtual line VL.

Thereby, all of the output Fx1, the output Fy1, the output Fx2, the output Fy2, the output Fx3, the output Fy3, the output Fx4, and the output Fy4 for calculation of the first translational force component fx1 show values not zero. Similarly, the output Fx5, the output Fy5, the output Fx6, the output Fy6, the output Fx7, the output Fy7, the output Fx8, and the output Fy8 for calculation of the second translational force component fx2 show values not zero. Accordingly, the above described difference |fx1−fx2| between the first translational force component fx1 and the second translational force component fx2 reflects values output from the larger number of crystal orientations of the quartz crystal plates contained in the sensor units 2211 to 2214 and the sensor units 2221 to 2224. As a result, step S2 of determining whether or not the first force sensor 221 or the second force sensor 222 is abnormal in the above described manner determines the health based on the outputs from the larger number of crystal orientations in the quartz crystal plates. Therefore, the possibility of missing an abnormality may be reduced and reliability of the robot 1 may be further improved.

Note that, for example, in the case of the sensors using quartz crystal, the above described output axes refer to axes along which strain can be detected, which are determined by the crystal orientations of the quartz crystal. In other detection principles, similarly, the output axes refer to axes along which forces can be detected.

### Second Embodiment

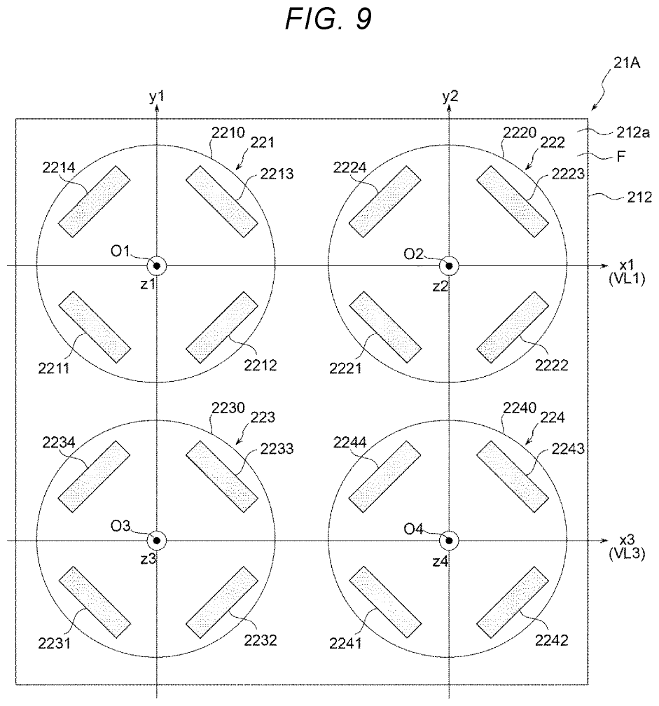

FIG. 8 is the exploded perspective view showing a force detection unit contained in a robot according to the second embodiment of the present disclosure. FIG. 9 shows a force detection unit 21A shown in FIG. 8 as seen from vertically above.

As below, the second embodiment will be explained with a focus on the differences from the above described embodiment and the explanation of the same items will be omitted. Note that, in FIGS. 8 and 9, the same configurations as those of the above described first embodiment have the same signs.

As shown in FIG. 8, the second embodiment is the same as the first embodiment except that a third force sensor 223 and a fourth force sensor 224 are provided in addition to the first force sensor 221 and the second force sensor 222. That is, the robot 1 further has the third force sensor 223 and the fourth force sensor 224.

These third force sensor 223 and fourth force sensor 224 are also placed between the first member 211 and the second member 212 with the first force sensor 221 and the second force sensor 222 and arranged on the plane F with the normal line along the vertical direction.

The four sensors are provided as described above, and the robot 1 may be stabilized. That is, the four sensors are provided, and thereby, the number of coupling points between the first member 211 and the second member 212 may be made larger and the distribution range of the coupling points may be made wider compared to those of the first embodiment, and thus, rigidity of the force detection unit 21A is higher. Accordingly, deformation of the force detection unit 21A with the operation of the robot 1 may be suppressed and the positioning accuracy may be further improved.

The first force sensor 221 shown in FIG. 9 is substantially the same as that of the first embodiment, but different in that translational forces with respect to an x1-axis, a y1-axis, and a z1-axis of a first sensor coordinate system shown in FIG. 9 and moment about the x1-axis, the y1-axis, and the z1-axis may be obtained.

Further, the second force sensor 222 shown in FIG. 9 is substantially the same as that of the first embodiment, but different in that translational forces with respect to an x1-axis, a y2-axis, and a z2-axis of a second sensor coordinate system shown in FIG. 9 and moment about the x1-axis, the y2-axis, and the z2-axis may be obtained.

Note that the x1-axis in the first sensor coordinate system and the x1-axis in the second sensor coordinate system are common.

On the other hand, the third force sensor 223 shown in FIG. 9 is a six-axis force sensor including a casing 2230 and four sensor units 2231 to 2234 provided within the casing 2230. Predetermined calculation processing is performed on outputs from these sensor units 2231 to 2234, and thereby, translational forces with respect to an x3-axis, a y1-axis, and a z3-axis of a third sensor coordinate system shown in FIG. 9 and moment about the x3-axis, the y1-axis, and the z3-axis may be obtained.

The configurations of the sensor units 2231 to 2234 are the same as e.g. the configurations of the sensor units 2211 to 2214.

Further, as shown in FIG. 9, the four sensor units 2231 to 2234 are placed at equal angular intervals around a center O3.

The fourth force sensor 224 shown in FIG. 9 is a six-axis force sensor including a casing 2240 and four sensor units 2241 to 2244 provided within the casing 2240. Predetermined calculation processing is performed on outputs from these sensor units 2241 to 2244, and thereby, translational forces with respect to an x3-axis, a y2-axis, and a z4-axis of a fourth sensor coordinate system shown in FIG. 9 and moment about the x3-axis, the y2-axis, and the z4-axis may be obtained.

The configurations of the sensor units 2241 to 2244 are the same as e.g. the configurations of the sensor units 2211 to 2214.

Further, as shown in FIG. 9, the four sensor units 2241 to 2244 are placed at equal angular intervals around a center O4.

Note that the x3-axis in the third sensor coordinate system and the x3-axis in the fourth sensor coordinate system are common.

Further, the y1-axis in the first sensor coordinate system and the y1-axis in the third sensor coordinate system are common.

Furthermore, the y2-axis in the second sensor coordinate system and the y2-axis in the fourth sensor coordinate system are common.

In FIG. 9, the x1-axis respectively passes between the sensor unit 2211 and the sensor unit 2214 and between the sensor unit 2212 and the sensor unit 2213, and between the sensor unit 2221 and the sensor unit 2224 and between the sensor unit 2222 and the sensor unit 2223.

Further, in FIG. 9, the x3-axis respectively passes between the sensor unit 2231 and the sensor unit 2234 and between the sensor unit 2232 and the sensor unit 2233, and between the sensor unit 2241 and the sensor unit 2244 and between the sensor unit 2242 and the sensor unit 2243.

In FIG. 9, the y1-axis respectively passes between the sensor unit 2211 and the sensor unit 2212 and between the sensor unit 2213 and the sensor unit 2214, and between the sensor unit 2231 and the sensor unit 2232 and between the sensor unit 2233 and the sensor unit 2234.

Further, in FIG. 9, the y2-axis respectively passes between the sensor unit 2221 and the sensor unit 2222 and between the sensor unit 2223 and the sensor unit 2224, and between the sensor unit 2241 and the sensor unit 2242 and between the sensor unit 2243 and the sensor unit 2244.

Also, in the above described force detection unit 21A, whether or not there is an abnormality in the force sensors may be determined in the same manner as that of the first embodiment, and an abnormality of the force detection unit 21A may be found earlier. As a result, the reliability of the robot 1 may be further improved.

Note that, for abnormality determination, for example, twos of the four sensors may be arbitrarily selected and the abnormality may be determined based on whether or not the difference between the translational force components exceeds a threshold value with respect to the two sets of sensors in the same manner as that of the first embodiment.

For example, in FIG. 9, the first force sensor 221, the second force sensor 222, the third force sensor 223, and the fourth force sensor 224 are placed to be located in the corners of a square. Further, the x1-axis is set as a virtual line VL1 and the x3-axis is set as a virtual line VL3.

In addition, in the force detection unit 21A shown in FIG. 9, the first force sensor 221 and the second force sensor 222 form one set and the third force sensor 223 and the fourth force sensor 224 form the other set. In the respective sets, the differences between the translational force components on the virtual lines VL1, VL3 are respectively calculated and whether or not there is an abnormality in the sensors is determined based on the differences in the same manner as that of the first embodiment. Thereby, even in the case where the four sensors are used, one of the four sensors may be determined as being abnormal earlier.

Note that, in this case, the determination is repeated while the combinations are changed, and thereby, the abnormal one of the four sensors may be specified. Accordingly, not only the determination as to whether or not there is an abnormality in the four sensors but also the specification of the sensor in which the abnormality occurs can be made. As a result, work including replacement and repair of the sensors may be easily performed.

Further, the detection value of the force by the force detection unit 21A may be detected with higher accuracy. Note that, in the calculation of the resultant force, for example, of the four sensors, two sets of two sensors may be selected and the resultant forces may be respectively calculated for the respective sets in the same manner as that of the first embodiment. Then, the resultant forces calculated in the respective sets may be used for averaging calculation or other calculation as appropriate.

Also, in the force detection unit 21A, the output axis of the first force sensor 221 and the output axis of the second force sensor 222 are respectively nonparallel to the virtual line VL1 and the output axis of the third force sensor 223 and the output axis of the fourth force sensor 224 are respectively nonparallel to the virtual line VL3. Accordingly, in the force detection unit 21A, the possibility of missing an abnormality may be reduced and reliability of the robot 1 may be further improved.

Next, a force detection unit 21B as a modified example of the force detection unit 21A will be explained.

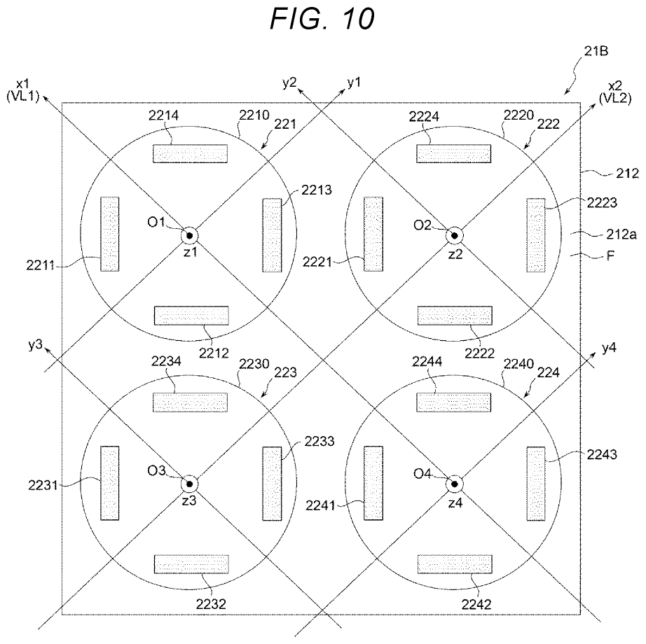

FIG. 10 shows the modified example of the force detection unit 21A shown in FIG. 9. Note that, in FIG. 10, the same configurations as those of the above described second embodiment have the same signs. Further, the explanation of the same items will be omitted.

A first force sensor 221 shown in FIG. 10 is the same as that of the first embodiment.

Further, a second force sensor 222 shown in FIG. 10 is substantially the same as that of the first embodiment, but different in that translational forces with respect to an x2-axis, a y2-axis, and a z2-axis of a second sensor coordinate system shown in FIG. 10 and moment about the x2-axis, the y2-axis, and the z2-axis may be obtained.

A third force sensor 223 shown in FIG. 10 may obtain translational forces with respect to an x2-axis, a y3-axis, and a z3-axis of a third sensor coordinate system shown in FIG. 10 and moment about the x2-axis, the y3-axis, and the z3-axis.

Further, a fourth force sensor 224 shown in FIG. 10 may obtain translational forces with respect to an x1-axis, a y4-axis, and a z4-axis of a fourth sensor coordinate system shown in FIG. 10 and moment about the x1-axis, the y4-axis, and the z4-axis.

The x1-axis in the first sensor coordinate system and the x1-axis in the fourth sensor coordinate system are common.

The x2-axis in the second sensor coordinate system and the x2-axis in the third sensor coordinate system are common.

Also, in the above described force detection unit 21B, the rigidity may be improved and the positioning accuracy of the robot 1 may be further improved. Further, whether or not there is an abnormality in the force sensors may be determined like the force detection unit 21A, and an abnormality of the force detection unit 21B may be found earlier. As a result, the reliability of the robot 1 may be further improved.

Note that, for abnormality determination, for example, twos of the four sensors may be arbitrarily selected and the abnormality may be determined based on whether or not the difference between the translational force components exceeds a threshold value with respect to the two sets of sensors in the same manner as that of the first embodiment.

For example, in FIG. 10, the first force sensor 221, the second force sensor 222, the third force sensor 223, and the fourth force sensor 224 are placed to be located in the corners of a square. Further, the x1-axis is set as a virtual line VL1 and the x2-axis is set as a virtual line VL2.

In addition, in the force detection unit 21B shown in FIG. 10, the first force sensor 221 and the fourth force sensor 224 form one set and the second force sensor 222 and the third force sensor 223 form the other set. In the respective sets, the differences between the translational force components on the virtual lines VL1, VL2 are respectively calculated and whether or not there is an abnormality in the sensors is determined based on the differences in the same manner as that of the first embodiment. Thereby, even in the case where the four sensors are used, one of the four sensors may be determined as being abnormal earlier.

Further, the detection value of the force by the force detection unit 21B may be detected with higher accuracy. That is, the resultant force obtained from the force detection unit 21B has higher accuracy compared to the resultant force obtained from the force detection unit 21A. This is because the resultant coordinate system in the force detection unit 21B is a coordinate system having the origin at the center of the above described square. Therefore, the resultant force obtained from the force detection unit 21B is obtained as a force regarded as being detected substantially at the center of the force detection unit 21B. Accordingly, the detection value of the force by the force detection unit 21B has higher accuracy compared to the detection value of the force by the force detection unit 21A.

Also, in the force detection unit 21B, the output axis of the first force sensor 221 and the output axis of the fourth force sensor 224 are respectively nonparallel to the virtual line VL1 and the output axis of the second force sensor 222 and the output axis of the third force sensor 223 are respectively nonparallel to the virtual line VL2. Accordingly, in the force detection unit 21B, the possibility of missing an abnormality may be reduced and the reliability of the robot 1 may be further improved.

According to the above described second embodiment, the same effects as those of the above described first embodiment may be exerted.

Note that the placement of the four sensors is not limited to the illustrated one, but may be any placement.

As above, the robot and the abnormality detection method of the robot according to the present disclosure are explained according to the illustrated embodiments, however, the present disclosure is not limited to those. The configurations of the respective parts may be replaced by arbitrary configurations having the same functions. Further, other arbitrary configurations may be added to the present disclosure.

The number of force sensors of the force detection unit is not limited to two or four, but may be three, five, or more.

Further, the robot according to the present disclosure is not limited to the single-arm robot, but may be another robot e.g. a dual-arm robot or scalar robot as long as the robot has the robot arm. The number of arms of the robot arm is not limited to six, the number of the above described embodiments, but may be from one to five, seven, and more.

What is claimed is:

1. A robot comprising:
a robot arm;
a first member and a second member placed between a base of the robot arm and an installation part;
a first force sensor and a second force sensor placed in contact with both the first member and the second member on a plane in a normal direction along a direction in which the base and the installation part are arranged;
an on-virtual line component calculation part that obtains a translational force component on a virtual line from output of the first force sensor as a first translational force component and obtains a translational force component on the virtual line from output of the second force sensor as a second translational force component; and
a determination part that outputs a signal when determining that the first force sensor or the second force sensor is abnormal based on a difference between the first translational force component and the second translational force component.

2. The robot according to claim 1, further comprising a control unit that receives the signal from the determination part and restricts driving of the robot arm.

3. The robot according to claim 1, further comprising an external force calculation part that calculates a resultant force based on the output of the first force sensor and the output of the second force sensor.

4. The robot according to claim 1, wherein
the first force sensor and the second force sensor are respectively six-axis force sensors.

5. The robot according to claim 1, wherein
the first force sensor and the second force sensor are respectively sensors having quartz crystal.

6. The robot according to claim 1, further comprising a third force sensor and a fourth force sensor.

7. An abnormality detection method of a robot having
a robot arm,
a first member and a second member placed between a base of the robot arm and an installation part, and
a first force sensor and a second force sensor placed in contact with both the first member and the second member on a plane in a normal direction along a direction in which the base and the installation part are arranged,
the method comprising:
obtaining a translational force component on a virtual line from output of the first force sensor as a first translational force component and obtaining a translational force component on the virtual line from output of the second force sensor as a second translational force component; and
determining whether or not a difference between the first translational force component and the second translational force component exceeds a threshold value and, when the difference exceeds the threshold value, determining that the first force sensor or the second force sensor is abnormal.
